(19) United States
(12) Patent Application Publication
(10) Pub. No.: US 2011/0300901 A1
(43) Pub. Date: Dec. 8, 2011

(54) Intelligent Input Handling

(75) Inventors: Albert Shen, Seattle, WA (US); Andrew P. Begun, Redmond, WA (US)

(73) Assignee: MICROSOFT CORPORATION, Redmond, WA (US)

(21) Appl. No.: 12/792,598

(22) Filed: Jun. 2, 2010

(51) Int. Cl. H04M 1/00; G09G 5/00; G06F 3/02

(52) U.S. Cl. 455/556.1; 345/168; 345/156

(57) ABSTRACT

Various embodiments enable a device to utilize environmental state information and/or application state information to determine an appropriate response to received input. In at least some embodiments, a device receives input, obtains environmental information and/or application state information of the device, and evaluates input validity. Based upon the evaluated information and input, the device can behave in a manner that ignores the input, allows execution of associated operations, and or modifies the resultant behavior.

### BACKGROUND

With the advancement of technology, electronic devices have become increasingly smaller, resulting in more and more portable devices. In addition to becoming smaller, electronic devices have evolved to accept multiple forms of input from a user, such as via a touch screen, a keyboard input, keypad and the like. As devices become smaller and more portable, they can end up in locations or situations in which a user may inadvertently activate an input. For example, a user may place their cellular phone in a pant pocket and inadvertently call someone. The increase in device input mechanisms only amplifies this situation by exposing the user to multiple input triggers that might be inadvertently activated.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments enable a device to utilize environmental information and/or application state information to determine an appropriate response to a received input. In at least some embodiments, a device receives input, obtains environmental information and/or application state information of the device, and evaluates input validity. Based upon the evaluated information and input, the device can behave in a manner that ignores the input, allows execution of associated operations, and/or modifies a resultant behavior.

### BRIEF DESCRIPTION OF THE DRAWINGS

The same numbers are used throughout the drawings to reference like features.

FIG. 1 is an illustration of an environment in an example implementation in accordance with one or more embodiments

FIG. 2 illustrates a stack diagram that describes software layers in accordance with one or more embodiments.

FIG. 3 is a flow diagram that describes steps in a method in accordance with one or more embodiments.

FIG. 4 is a flow diagram that describes steps in a method in accordance with one or more embodiments.

FIG. 5 illustrates an example system that can be used to implement one or more embodiments.

### DETAILED DESCRIPTION

### Overview

Various embodiments enable a device to utilize environmental and/or application state information to determine an appropriate response to received input. In at least some embodiments, a device receives input, obtains evaluation metrics, such as environmental state information and/or application state information of the device, and evaluates input validity. Based upon the evaluated information and input, the device can determine a resultant behavior. For example, a device can decide to allow an operation based upon a first evaluation result, further decide to modify an operation based upon state information, and/or decide to disallow an operation based upon a second evaluation result.

In at least some embodiments, various sensors can be used to ascertain properties or characteristics associated with a device and its surrounding environment. For example, locational, orientational, and/or relational properties associated with the device and its surrounding environment can be ascertained and then utilized to make a decision on whether an input received by the device should be processed as usual. Specifically, in some situations the location of a device within its environment may be one in which an input should be ignored. For example, if a personal digital assistant (PDA) is placed in a purse, then a received inadvertent input, such as a button press, can be ignored. In other situations, the location of a device may cause modification of an operation associated with the input, such as adjusting what is displayed based upon the device's environment.

In the discussion that follows, a section entitled “Example Environment” is provided and describes one environment in which one or more embodiments can be employed. Following this, a section entitled “Evaluation Layer” describes how an evaluation layer can be employed to accept or reject input information, and modify responsive behavior in accordance with one or more embodiments. Last, a section entitled “Example System” describes an example system that can be used to implement one or more embodiments.

Consider now an example environment in which one or more embodiments can be implemented.

### Example Environment

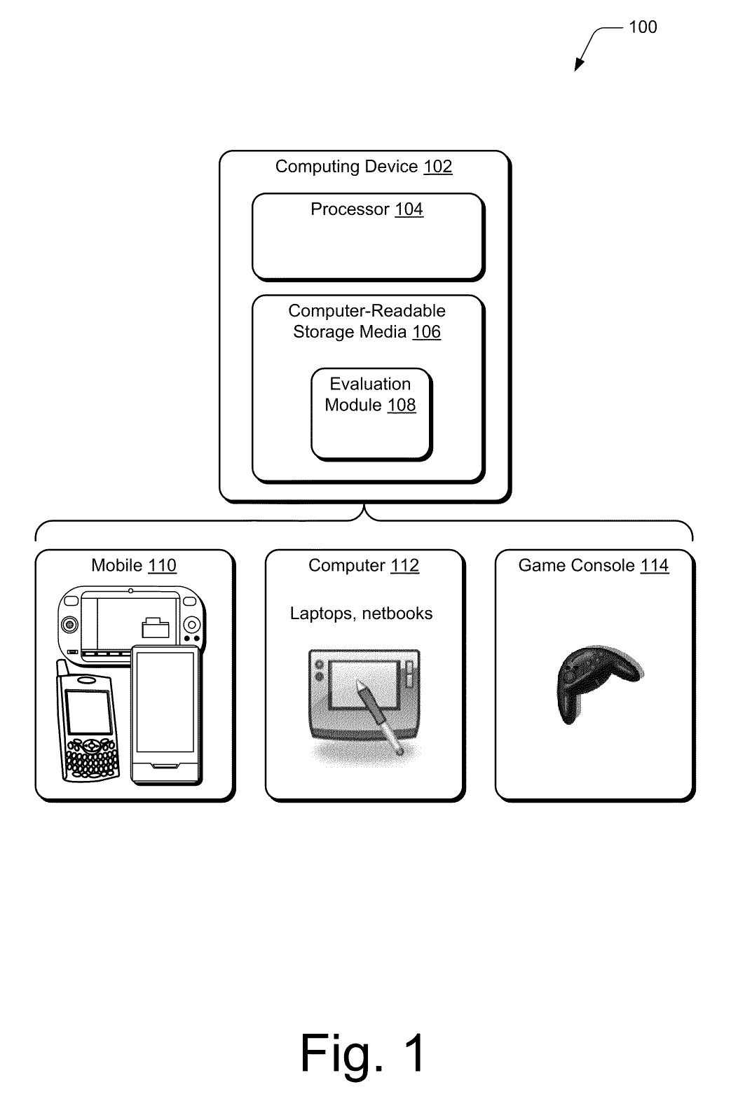

FIG. 1 illustrates an example environment in which intelligent input handling can be employed in accordance with one or more embodiments, generally at 100. Environment 100 includes a computing device 102 having one or more processors 104 and one or more computer-readable storage media 106 that may be configured in a variety of ways. In one or more embodiments, computer-readable storage media 106 can include an evaluation module 108 that operates as described above and below. The computing device 102 may assume a mobile device class 110 which includes mobile telephones, music players, PDAs, digital media players, and so on. The computing device 102 may also assume a computer device class 112 that includes personal computers, laptop computers, netbooks, and so on. The game console device class 114 includes configurations of devices that involve display in a casual environment, e.g., televisions, set-top boxes, game consoles, and so on. Thus, the techniques described herein may be supported by these various configurations of the computing device 102 and are not limited to the specific examples described in the following sections. The computing device 102 also includes software that causes the computing device 102 to perform one or more operations as described below.

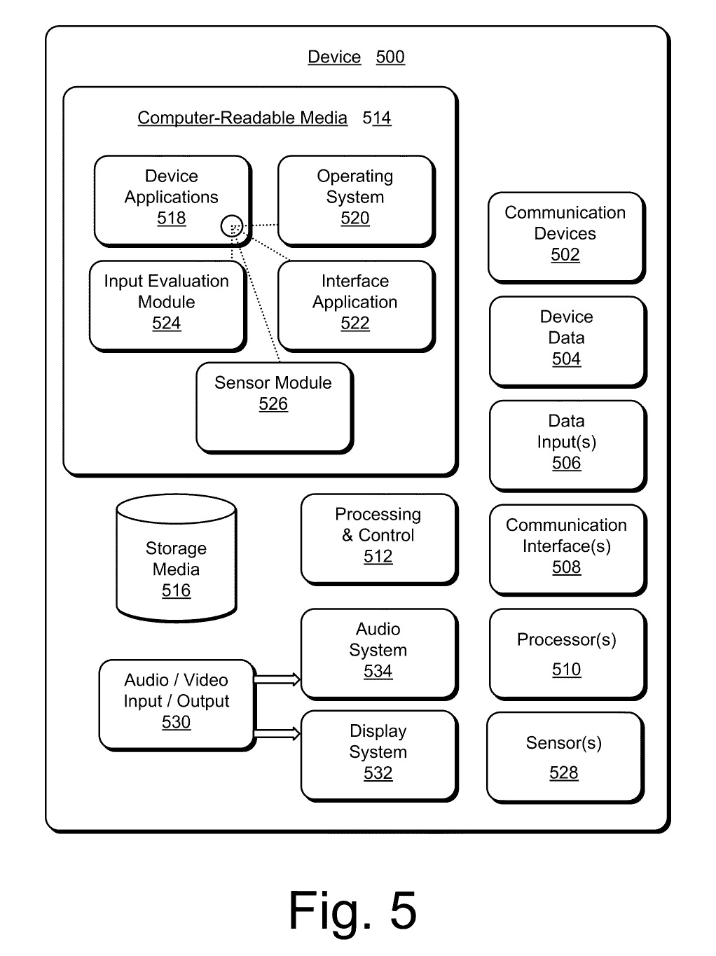

The computer-readable storage media 106 can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 5.

In operation, evaluation module 108 determines the validity of a received input. The evaluation module can do this by determining a device's environmental state, as well as application state, to assess whether the input appears to be intentional or not, given a particular environmental and/or application state. The evaluation module can further influence the device's resultant behavior or response to the input given the particular input and environmental and/or application state. For example, the evaluation module can determine that the current device application state and current device environment state warrants a modification in the device's resultant behavior given a received input, as described below in more detail.

Having described an example environment, consider now a discussion of how an evaluation layer can be implemented in accordance with one or more embodiments.

Evaluation Layer

Various embodiments provide an ability to evaluate the validity of a device input. In one or more embodiments, an evaluation layer is used to acquire an input message or event and assess whether the input appears to be intentional or not, given the device's environmental and/or application state. For example, if a device's input is unintentionally triggered, the evaluation layer can acquire information associated with the input, obtain device environment information, and then evaluate whether the input appears to be intentional or not given the device environment information. Based upon the state information and/or other rules, the evaluation layer can further ascertain whether the input should be processed to cause execution of an operation associated with the input, such as determining whether to allow further processing or to discard the input.

Device input allows a user to control a device and manage the functionality it executes. Multiple instrumentations exist which allow the user to interact with a device. For example, a power button can turn a device on and off, a soft key can navigate a menu system of a device, a touch screen can accept commands through physical contact, a keyboard can accept commands associated with alphanumeric characters, a sound sensor can accept commands through audible conveyances, and so forth. Thus, input, whether intentional or unintentional, can be triggered in multiple ways. In one or more embodiments, the device, through its input evaluation layer, can determine an associated response or reaction to the input.

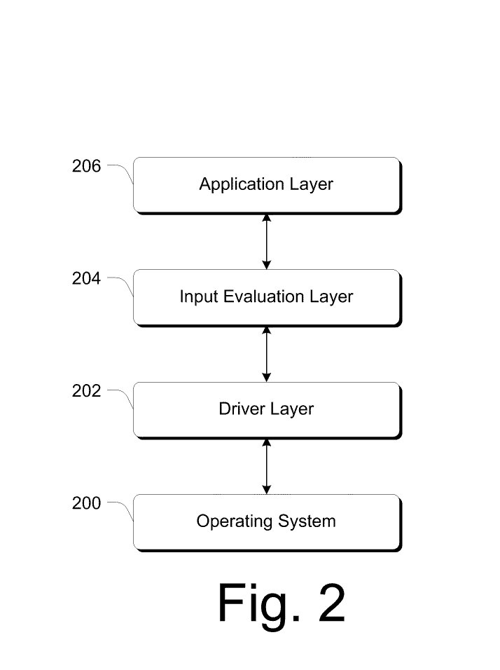

As an example of an evaluation layer, consider FIG. 2 which illustrates an example of a general device stack including an evaluation layer. Operating system 200 includes software that communicates with device hardware on a low level. Operating system 200 manages hardware resources in the device, such as memory access, peripheral access, and the like. Driver layer 202 is operably coupled with operating system 200 and uses the operating system to expose hardware access and/or information to higher layer applications, such as application layer 206. As a user triggers an input mechanism of the device, driver layer 202 can intercept the information associated with the input, such as a message or event, and pass the information to application layer 206 for further processing. For example, in one or more embodiments, as a user selects an input mechanism, the input mechanism can generate a hardware interrupt in the device which, in turn, is handled by driver layer 202. Driver layer 202 can interpret the interrupt and pass necessary messages, events or other communications up to application layer 206.

In one or more embodiments, driver layer 202 can route input communications through an input evaluation layer 204. In the present example, the input evaluation layer resides logically between the driver layer 202 and the application layer 206. It is to be appreciated and understood, however, that input evaluation layer 204 could be located at any suitable location in the device stack without departing from the spirit of the claimed subject matter. For example, input evaluation layer 204 could be implemented as a part of driver layer 202, as a part of application layer 206, or could reside logically above application layer 206.

In operation, input evaluation layer 204 receives information associated with a device input and determines the validity of the input. In at least some embodiments, a user does not need to specify when input is invalid. For example, the user does not need to select key-lock functionality in order to specify that subsequently-received input may be unintentional or invalid. Input evaluation layer 204 can contain one or more rules by which a device input is validated and/or evaluated. In another example, input evaluation layer 204 can, responsive to receiving information associated with a device input, query application layer 206 for application state information as well as query device hardware for device state information. Based upon this information, the input can be assessed to be intentional or unintentional. Based on this assessment, a decision with respect to an appropriate action to be taken can be made.

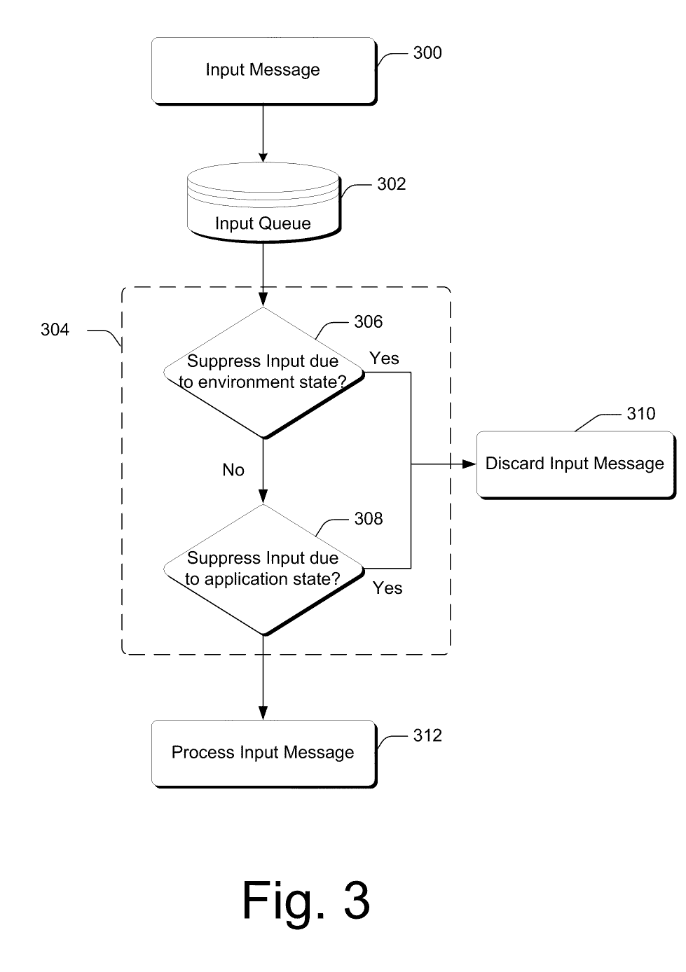

As an example, consider FIG. 3, which is an illustration of a decision tree in accordance with one or more embodiments. An input message 300 associated with a device input is generated and stored in an input queue 302. It is to be appreciated and understood, however, that any means of communication can be used to signify a device input without departing from the spirit of the claimed subject matter. For example, instead of generating an input message and storing the message in an input queue, an event or delegate can be utilized to signify a device input.

Logic block 304 contains logic and/or rules or decision points associated with evaluating the validity of input message 300 given a device's current environmental state and/or application state. While FIG. 3 illustrates only two evaluations—decision point 306 and decision point 308—logic block 304 can be implemented with any suitable number and combination of rules and/or logic. In addition to containing any number or combination of rules, logic block 304 can obtain evaluation rules and/or logic in various ways. For example, a database or file can be queried dynamically to retrieve a current set of evaluation rules. In another example, logic block 304 can contain hardcoded rules or a mixture of hardcoded rules and dynamically obtained rules. Alternately or additionally, the behavior of the device can be determined based on one or more criteria, as further described below.

Decision point 306 evaluates whether the device input, and the execution of associated operations, should be suppressed due to the device's environment state information. For example, in one or more embodiments, environmental state information associated with the device can be determined through use of a sensor, such as a proximity sensor. A proximity sensor can be used to detect the proximity of objects relative to the device. If one or more objects are found to be near the device, a determination can be made that the device is inactive and that the input was unintentional. If input is determined to be unintentional, the decision tree proceeds to block 310 and discards the input message. While the example above describes the use of a proximity sensor, it is to be appreciated and understood, however, that a device's environmental state can be determined in any suitable way, such as through a light sensor, an accelerometer, and the like.

If decision point 306 determines that input is intentional, the decision tree proceeds to decision block 308. Decision block 308 evaluates whether the device input should be suppressed due to information associated with one or more device application states. For example, in one or more embodiments, application layer 206 (FIG. 2) can be queried for information on active and idle applications, queried for process state information, and so forth. In another example, applications can dynamically update state information in evaluation layer 204. Individual applications can define state information independent of other applications, thus allowing input validation to be evaluated on an application by application basis. Based upon obtained application state, decision block 308 may determine to proceed to block 310 and discard the input. For instance, a video game application state could specify that input from taps on a screen are discarded if the game is controlled by specific keyboard keys. Similarly, decision block 308 may determine to proceed to block 312 and process the input.

As described above, decision block 308 may determine an input message is intentional and proceed to block 312. While not shown in FIG. 3, application state and/or device state information can prompt modified responses or behavior for the same input. For example, an input message that causes a display to have bright intensity may have a modified response to have less intensity based upon application state information. In another example, an input message that causes a device to play a ringtone may have a modified response to mute the ringtone based upon device state information. Thus, an operation associated with the input can be modified based upon device state information.

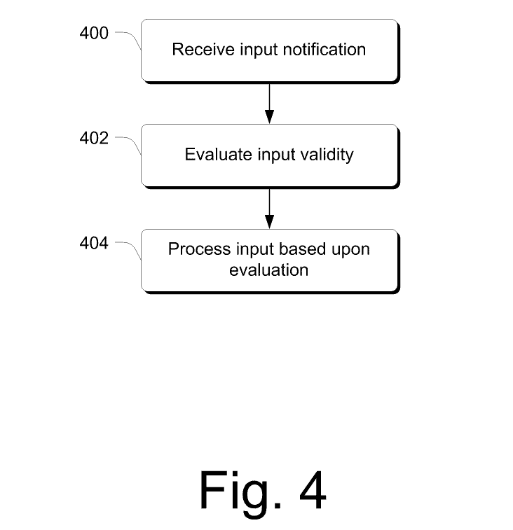

FIG. 4 is a flow diagram that describes steps in a method in accordance with one or more embodiments. The method can be implemented in connection with any suitable hardware, software, firmware or combination thereof. In at least some embodiments, aspects of the method can be implemented by a suitably configured software module, such as evaluation module 108 (FIG. 1).

Step 400 receives input notification. This step can comprise any suitable type of input notification and can be performed in any suitable way, examples of which are provided above. Step 402 evaluates input validity. In one or more embodiments, evaluating input validity can include using one or more rules and/or logic to evaluate the input and device state information. Rules and/or logic can be a set of fixed rules, a set of dynamically obtained rules, or any combination thereof. As described above, this can encompass using information associated with device state and/or application state to evaluate the input. Step 404 processes the input based upon the evaluation. For example, if input is evaluated to be invalid or unintentional, the input can be ignored as by discarding the input notification. If input is evaluated to valid or intentional, the input can be processed accordingly as by passing on the input notifications to the appropriate processing entities.

Having described various embodiments of an evaluation layer, consider now an operating environment that can be utilized to implement one or more of the above-described embodiments.

### Example System

FIG. 5 illustrates various components of an example device 500 that can be implemented as any type of portable and/or computer device as described with reference to FIG. 1 to implement embodiments of the intelligent input handling described herein. Device 500 includes communication devices 502 that enable wired and/or wireless communication of device data 504 (e.g., received data, data that is being received, data scheduled for broadcast, data packets of the data, etc.). The device data 504 or other device content can include configuration settings of the device, media content stored on the device, and/or information associated with a user of the device. Media content stored on device 500 can include any type of audio, video, and/or image data. Device 500 includes one or more data inputs 506 via which any type of data, media content, and/or inputs can be received, such as user-selectable inputs, messages, music, television media content, recorded video content, and any other type of audio, video, and/or image data received from any content and/or data source.

Device 500 also includes communication interfaces 508 that can be implemented as any one or more of a serial and/or parallel interface, a wireless interface, any type of network interface, a modem, and as any other type of communication interface. The communication interfaces 508 provide a connection and/or communication links between device 500 and a communication network by which other electronic, computing, and communication devices communicate data with device 500.

Device 500 includes one or more processors 510 (e.g., any of microprocessors, controllers, and the like) which process various computer-executable or readable instructions to control the operation of device 500 and to implement the intelligent input handling described above. Alternatively or in addition, device 500 can be implemented with any one or combination of hardware, firmware, or fixed logic circuitry that is implemented in connection with processing and control circuits which are generally identified at 512. Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 500 also includes computer-readable media 514, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 500 can also include a mass storage media device 516.

Computer-readable media 514 provides data storage mechanisms to store the device data 504, as well as various device applications 518 and any other types of information and/or data related to operational aspects of device 500. For example, an operating system 520 can be maintained as a computer application with the computer-readable media 514 and executed on processors 510. The device applications 518 can include a device manager (e.g., a control application, software application, signal processing and control module, code that is native to a particular device, a hardware abstraction layer for a particular device, etc.). The device applications 518 also include any system components or modules to implement embodiments of the intelligent input handling described herein. In this example, the device applications 518 include an interface application 522, an input evaluation module 524, and sensor module 526 that are shown as software modules and/or computer applications. The input evaluation module 524 is representative of software that is used to provide evaluation and validation of device input. Sensor module 526 is representative of software that controls and/or interprets data returned from sensors 528. Alternatively or in addition, the interface application 522, the input evaluation module 524 and the sensor module 526 can be implemented as hardware, software, firmware, or any combination thereof.

Device 500 includes sensor(s) 528 that receive and/or provide one or more metric of the environmental state of example device 500. For example, sensor module 528 can be a proximity sensor, light sensor, accelerometer, sound sensor, temperature sensor, pressure sensor, and the like.

Device 500 also includes an audio and/or video input-output system 530 that provides audio data to an audio system 534 and/or provides video data to a display system 532. The audio system 534 and/or the display system 532 can include any devices that process, display, and/or otherwise render audio, video, and image data. Video signals and audio signals can be communicated from device 500 to an audio device and/or to a display device via an RF (radio frequency) link, S-video link, composite video link, component video link, DVI (digital video interface), analog audio connection, or other similar communication link. In an embodiment, the audio system 534 and/or the display system 532 are implemented as external components to device 500. Alternatively, the audio system 534 and/or the display system 532 are implemented as integrated components of example device 500.

### CONCLUSION

Various embodiments enable a device to utilize environmental state information and/or application state information to determine an appropriate response to received input. In at least some embodiments, a device can receive input, obtain environmental information and/or application state information, evaluate input validity based upon the information, and determine the device's behavior. Based upon the evaluated information and input, a device can ignore the input or modify the resultant behavior.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
receiving input from a device;
responsive to receiving said input, obtaining device state information;
evaluating the input based upon the device state information to ascertain whether the input should be processed to cause an operation associated with the input;
allowing the operation responsive to a first evaluation result; and
disallowing the operation responsive to a second evaluation result.

2. The method of claim 1, wherein obtaining the device state information comprises obtaining information associated with the device's environment.

3. The method of claim 2, wherein obtaining device environment state information further comprises using a proximity sensor to ascertain whether the device is near one or more objects.

4. The method of claim 1, wherein obtaining device state information comprises obtaining information associated with one or more device application states.

5. The method of claim 1, wherein allowing the operation responsive to a first evaluation result further comprises modifying the operation based upon device state information.

6. The method of claim 1, further comprising dynamically obtaining one or more rules by which the device state information is evaluated.

7. The method of claim 1, wherein receiving input from a device comprises receiving the input via a keypad.

8. The method of claim 1, wherein evaluating the input comprises evaluating the input without data from key-lock functionality.

9. One or more computer-readable storage media embodying computer-executable instructions that are executable to:
receive input from a telephone;
responsive to receiving said input, obtain state information associated with the telephone;
evaluate the input based upon the state information to ascertain whether the input should be processed to cause an operation associated with the input;
allow the operation responsive to a first evaluation result; and
disallow the operation responsive to a second evaluation result.

10. The computer-readable storage media of claim 9, wherein instructions to obtain state information associated with the telephone comprise instructions to obtain information associated with the telephone's environment state.

11. The computer-readable storage media of claim 10, wherein instructions to obtain state information associated with the telephone further comprise instructions to use a proximity sensor to ascertain whether the telephone is near one or more objects.

12. The computer-readable storage media of claim 9, wherein instructions to obtain state information associated with the telephone further comprise instructions to obtain information associated with one or more telephone application states.

13. The computer-readable storage media of claim 9, wherein instructions to allow the operation responsive to a first evaluation result further comprise instructions to modify the operation based upon telephone state information.

14. The computer-readable storage media of claim 9, wherein instructions to evaluate the input further comprise instructions to evaluate the input without data from key-lock functionality.

15. A device comprising:
one or more processors;
one or more sensors;
one or more input mechanisms;
one or more computer-readable storage media;
an evaluation module embodied on the computer-readable storage media, the evaluation module configured to implement a method, under the influence of the one or more processors, the method comprising:
receiving input via at least one of the one or more input mechanisms;
obtaining device state information;
evaluating the input based upon the device state information to ascertain whether the input relative to the device state information satisfies one or more criteria associated with an inadvertent input; and
determining a device behavior based upon the input and said evaluation.

16. The device of claim 15, wherein obtaining device state information comprises obtaining information associated with the device's environment.

17. The device of claim 15, wherein one or more sensors comprise a proximity sensor.

18. The device of claim 15, wherein the evaluating the input comprises evaluating the input without data from key-lock functionality.

19. The device of claim 15, wherein the determining the device behavior comprises determining to suppress execution of the input if the input satisfies the one or more criteria.

20. The device of claim 15, wherein one or more one or more input mechanisms is a keypad.
